(19) United States
(12) Patent Application Publication
(10) Pub. No.: US 2013/0117802 A1
(43) Pub. Date: May 9, 2013

(54) AUTHORIZATION-BASED REDACTION OF DATA

(71) Applicant: Patrick Fendt, Suwanee, GA (US)

(72) Inventor: Patrick Fendt, Suwanee, GA (US)

(21) Appl. No.: 13/288,909

(22) Filed: Nov. 3, 2011

(51) Int. Cl. G06F 21/00

(52) U.S. Cl. 726/1; 726/4

(57) ABSTRACT

Tasks for providing a post-redaction document to a requestor are distributed among several distinct components. The decision about whether a particular requestor is permitted to obtain a requested content item is made by an authorization service. When obtaining requested content item is permitted, the authorization service returns (a) portion identification information, and (b) redaction technique information that indicates the manner by which that portion should be redacted. Redaction is then performed by a redaction component. Techniques are described in which the portion identification information identifies portions to be redacted using XPath expressions, and the redaction component has logic to identify the portions, within the pre-redaction version of the content item, that are targeted by the XPath expressions.

### CROSS-REFERENCE TO RELATED APPLICATIONS; BENEFIT CLAIM

This application is related to U.S. Pat. No. 7,748,027 filed Sep. 8, 2005, the entire contents of which is hereby incorporated by reference as if fully set forth herein.

### FIELD OF THE INVENTION

The present invention relates to automated redaction and, more specifically, to invoking a redaction module to produce redacted version of content items prior to providing the content items to requestors.

### BACKGROUND

Content items may take a variety of forms, including documents, videos, audio recordings, etc. Content items need not exist before they are requested. For example, XML documents and a web pages are often dynamically generated in response to requests. Further, the data from which such content items are dynamically generated may come from many sources. For example, in response to a request for an XML document, a middle-ware module may send requests to several disparate database systems, and dynamically generate the XML document by aggregating and formatting the results obtained from those database systems.

Various systems are available to allow users to selectively publish the content items they own or control. Such selective publication systems not only determine which parties are able to access a content item, but may also be used to enforce rules about which parts of the content items those parties are allowed to access. For example, in situations where a particular party is allowed to access only certain parts of a content item, the portions of the content item that the party is not allowed to access may be automatically redacted before the content item is provided to the party.

Currently, there are numerous challenges with the way automatic redaction is being performed in the information technology industry, and in particular how redaction is performed within message-based and Service-Oriented Architecture (SOA) environments. For example, transport-based encryption (e.g. using TLS/SSL) involves relying on transport encryption for redacting sensitive data flowing within a SOA. Transport encryption typically occurs within a specific point-to-point segment between two machines. Consequently, transport encryption does not provide security from a broader end-to-end standpoint, where messages are flowing among multiple machines across a wide-area network, such as the Internet.

Due to the segmented, point-to-point nature of transport encryption, there is an increased chance that the decrypted data at any point in the end-to-end flow will be revealed. For example, a message flowing into a server via TLS is typically immediately decrypted and passed up the layers of the architecture stack and, without regard to the application or user, is now in clear-text form. Similarly, a proxy server commonly intercepts and decrypts the data—often before the data even gets to the web server.

In addition, transport encryption cannot selectively redact, encrypt or decrypt data based on a user's identity, a user's role, an authorization service or an authorization policy. Further, transport-based encryption cannot take into account multiple authorization (and redaction decision related) factors—such as user identity, user attributes, user role, time of day, service being requested, request data values, etc.

Non-SOA approaches to redaction are employed by some document-oriented redaction products that focus on authorizing and redacting use of information within a specific document. However, these products generally do not address the requirement to redact data relating to particular services, messages, or transaction types based on the authorization policy associated with a message, service or transaction. Thus, these products typically cannot support an OLTP and SOA-based message processing environment.

In environments where the contents of a document must be retrieved from many sources, it is inefficient to have redaction logic built-in to the modules associated with each of the sources. For example, assume that the data for a requested XML document resides in databases A, B and C. Assume further that the data needed from databases A, B and C is obtained by modules X, Y and Z, respectively. Under these circumstances, it would be inefficient for modules X, Y and Z to each implement redaction logic to redact, from their respective data portions, those parts of the document that are not to be provided to the party that is requesting the XML document. Moreover, the inefficiencies in this approach occur both during development of the system, as well as during runtime usage of the system.

The approaches described in this section are approaches that could be pursued, but not necessarily approaches that have been previously conceived or pursued. Therefore, unless otherwise indicated, it should not be assumed that any of the approaches described in this section qualify as prior art merely by virtue of their inclusion in this section.

### BRIEF DESCRIPTION OF THE DRAWINGS

In the drawings:

FIG. 1 is a block diagram of a system configured to perform automated redaction, according to an embodiment of the invention; and

FIG. 2 is a block diagram of a computer system upon which embodiments of the invention may be implemented.

### DETAILED DESCRIPTION

In the following description, for the purposes of explanation, numerous specific details are set forth in order to provide a thorough understanding of the present invention. It will be apparent, however, that the present invention may be practiced without these specific details. In other instances, well-known structures and devices are shown in block diagram form in order to avoid unnecessarily obscuring the present invention.

### General Overview

An automated redaction system is provided in which the tasks associated with providing a post-redaction document to a requestor are distributed among several distinct components. According to one embodiment, the decision about whether a particular requestor is permitted to obtain a requested content item is made by an authorization service. In cases where the requestor is permitted to obtain the requested content item, the authorization service returns “redaction obligations”.

In one embodiment, each redaction obligation includes (a) portion identification information that indicates which portion(s) of the content item to redact prior to providing the content item to the requestor, and (b) redaction technique information that indicates the manner by which that portion should be redacted. The different ways portions can be redacted are based, at least in part, on the nature of the content item involved. Those ways can include, for example: deleted, blanked out, replaced with “filler”, encrypted, etc. Certain types of redactions require additional parameters. For example, if redaction is done by encryption, the redaction technique information indicates the encryption technique to use to perform the encryption.

Once the redaction obligations have been obtained, redaction requests are sent to a redaction component that has access to a pre-redaction version of the requested content item. The redaction requests include the portion identification information and the redaction technique information. In response to a redaction request, the redaction component performs the requested redaction in the requested manner, and returns a post-redaction version of the content item. The post-redaction version of the content item may then be provided to the requestor.

In one embodiment, the portion identification information identifies portions to be redacted using XPath expressions, and the redaction component has logic to identify the portions, within the pre-redaction version of the content item, that are targeted by the XPath expressions.

### System Overview

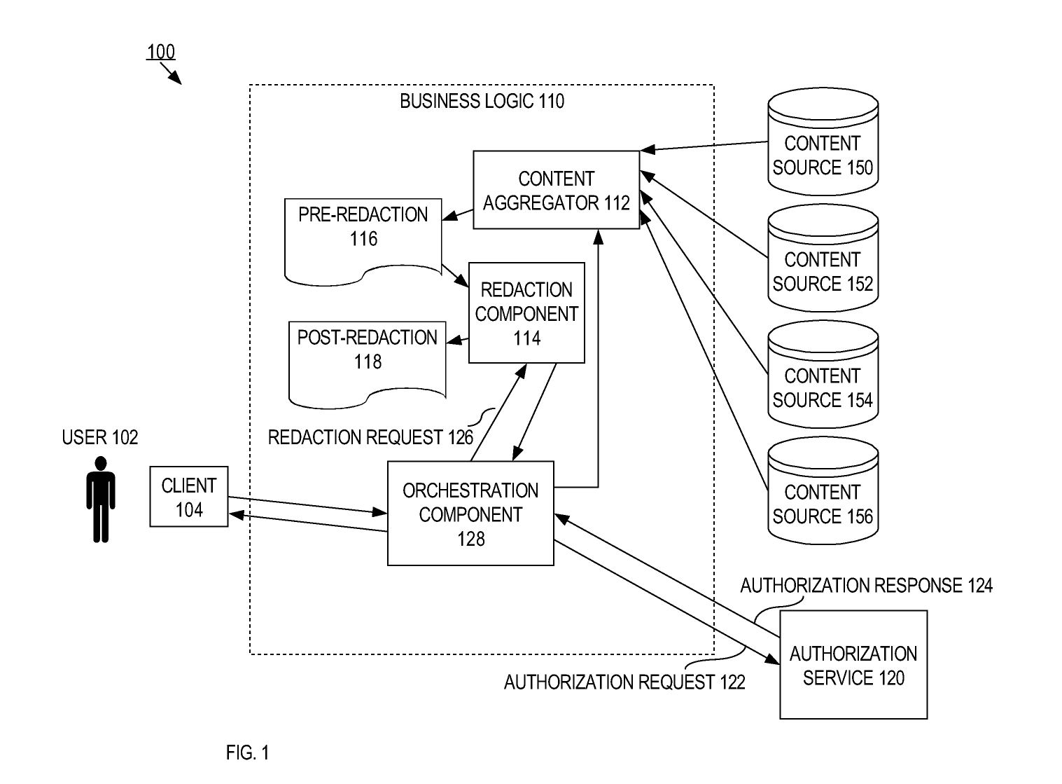

Referring to FIG. 1, it illustrates an automated redaction system 100, according to one embodiment, of the invention. System 100 includes business logic 110 that receives content item requests from clients, obtains the data necessary to create pre-redaction versions of requested content items, redacts the portions of those content items, and provides post-redaction versions of the content items to the clients from which the requests were received. In the embodiment illustrated in FIG. 1, orchestration component 128 represents the module(s) within business logic 110 to which a content item request is directed.

For the purpose of explanation, FIG. 1 illustrates a single client 104 that is being used by a user 102 to send a content item request to business logic 110. However, there is no limit to the number of users and clients that may concurrently or serially request content items from business logic 110.

In the illustrated embodiment, orchestration component 128 calls an authorization service 120 to determine whether a requestor is permitted to access a requested content item and, if so, which portions of that content item need to be redacted prior to providing the requested content item to the requestor. The manner by which authorization service 120 determines whether to a requestor is permitted to access an item, and which portions of the item need to be redacted, shall be described in greater detail hereafter.

Content sources 150-156 generally represent the sources from which content must be retrieved to create a pre-redaction version of a requested content item. For example, content sources 150-156 may include one or more relational database systems, mainframes, UNIX machines, etc. There is no limit to the type or number of content sources from which data must be obtained to create pre-redaction versions of requested content items.

Some types of content sources, such as relational database systems, may have mechanisms by which some forms of redaction can be performed locally, prior to providing the data to the business logic 110. However, a system that attempts to instruct each content source to separately perform redactions on its respective portion of a requested content item is not practical, given the potentially wide range of types of content sources that may be involve in providing data for any given request.

Therefore, as illustrated in FIG. 1, content from the content sources 150-156 is aggregated within the business logic 110 to create a pre-redaction version 116 of each requested content item. The module(s) within business logic 110 that are responsible for collecting and aggregating the content from the various sources are generally represented by content aggregator 112.

The pre-redaction version 116 produced by content aggregator 112 is made available to a redaction component 114. Redaction component 114 redacts information from the pre-redaction version 116 to produce a post-redaction version of the content item 118. The post-redaction version of the content item 118 is then provided to the requestor (e.g. client 104). The post-redaction version of the content item 118 may be provided, for example, by redaction component 114 making the post-redaction version of the content item 118 available to the orchestration component 128, and the orchestration component 128 returning the post-redaction version of the content item 118 to the client 104 as a response to the initial request.

In one embodiment, the redactions performed by redaction component 114 are performed based on redaction instructions that are sent to redaction component 114 from orchestration component 128. As shall be described in detail hereafter, those redaction instructions are based on “Obligations” that the orchestration component 128 receives from authorization service 120.

### The Authorization Service

As mentioned above, authorization service 120 is the component responsible for determining whether requestors are authorized to access the content items that the requestors request. Thus, authorization service 120 acts as a Policy Decision Point (PDP) for business logic 110. According to one embodiment, authorization service 120 makes authorization and redaction decisions based on a list of authorization policies. According to one embodiment, the authorization policies are pre-configured by administrators to meet the security and privacy requirements of the particular system implementation in which the authorization service 120 is employed.

Those authorization policies may indicate, for example, what content has to be redacted for any given role/content combination, where the “role” of a requestor dictates what information the requestor is allowed to access, and the “content” is the content to which the user is currently requesting access. In environments where specific services are used to provide specific content items, the authorization policies may be associated with role/service combinations.

For example, policies may establish rules such as:
If role=role1 and service=service1, then permit
If role=role2 and service=service1, then deny
If role=role3 and service=service1, then permit but redact XYZ using redaction technique ABC.
If role=role4 and service=service1, then permit but redact XYZ using redaction technique MTP.
If role=role4 and service=service1, then permit but redact RJQ using redaction technique NVP.
if role=role5 and service=service1, then permit but redact XYZ

Based on these example rules, requestors that request content items from service1 will receive different responses based on their roles. Specifically, a requestor with role1 would see the content provided by service1 without any redactions, and a requestor with role2 would not be provided anything from service1. A requestor with role3 would see the requested content with one portion redacted, while a requestor with role4 would see the requested content with two portions redacted, where the two portions were redacted using two different redaction techniques (e.g. deletion and encryption, or two different types of encryption). A requestor with role5 would see the requested content with one portion redacted, where a default redaction technique would be used to perform the redaction.

In one embodiment, the authorization response 124 that is generated by authorization service 120 in response to an authorization request 122 contains the three pieces of information: (1) an indication of whether the requestor is permitted to access the requested content item, (2) XPath expression(s) to indicate which portion(s) of the content item to redact, and (3) an indication of how to perform the redaction.

For example, when used in a SOA system, the authorization response 124 use the “Obligations” section of the XACML-based response message to return Obligations that contain one or more redaction directives. As a specific example, in the case where the content item request is for a health record from EMR or NHIN, the authorization response 124 may include the following Obligation:
Obligation name: PatientEHRNonPsych
Obligation method: remove
Obligation XPath Expression: /CCDHistory/[@recordtype=“Psychiatric”]

As another example, in the case where the content item request is a financial services account inquiry, the authorization response 124 may include the following Obligation:
Obligation name: CustSvcAcctInquiry
Obligation method: remove
Obligation XPath Expression: //*[name( )=“SSN”]

A content item request for a generic background check inquiry may cause authorization service 120 to generate an authorization response 124 with the Obligation:
Obligation name: BackgroundCheck
Obligation method: remove
Obligation XPath Expression: //*[name( )=“SSN”]

Similarly, a content item request for confidential classified information may cause authorization service 120 to return an authorization response 124 with the Obligation:
Obligation name: SecretOnlyDefaultView
Obligation method: encrypt/tripledes-cbc
Obligation XPath Expression: //*[@classification=“TopSecret”]

These are merely examples of the virtually unlimited types of redaction-related obligations that can be included in the authorization responses produced by authorization service 120. In addition, a single authorization response 124 may include many such obligations, each of which may designate a different XPath and a different redaction technique.

### The Redaction Component

While authorization service 120 makes the decision about what content needs to be redacted from any requested content item, and how the redaction is to be performed, the actual redaction operations are performed by a separate redaction component 114. According to one embodiment redaction component 114 is implemented as a web service that may be called by other web services as well as by orchestration components, such as orchestration component 128. As illustrated in FIG. 1, an orchestration component 128 may initiate a redaction operation by sending a redaction request 126 to redaction component 114.

The redaction request 126 includes data that identifies the portions of a content item to be redacted, and includes an indication of how the redaction is to be performed. In one embodiment, the portion(s) of the content item that are to be redacted are identified, within the redaction request 126, by XPath expressions. In an embodiment where the orchestration component 128 receives from the authorization service 120 XPath expressions that identify portions to be redacted, the orchestration component 128 may include those same XPath expressions in the redaction request 126 that the orchestration component 128 sends to the redaction component 114.

In response to the redaction request 126, redaction component 114 performs the requested redaction operations on the specified portion(s) of the pre-redaction version 116 of the target content item, thereby producing a post-redaction version 118 of the content item. The business logic 110 may then return the post-redaction version 118 of the content item to the client 104 of the requestor, as a response to the original content item request.

Significantly, redaction component 114 is separate from orchestration component 128, and therefore may be invoked by any one of several orchestration components, as well as other types of web services. This avoids the need for each of those orchestration components to separately implement redaction logic. Consequently, the architecture of business logic 110 is more modularized, allowing each component to focus on the specific task for which the component was designed.

In one embodiment, the redaction component 114 is deployed in an orchestration subsystem of business logic. The redaction component 114 is highly reusable and can be deployed in-process—in a way that supports high-performance OLTP requirements. As a result, redaction may be performed both on the incoming messages (inbound into the SOA-based middle tier) as well as the outgoing messages—being sent back to a service consumer. In one embodiment, such incoming messages may be asynchronous or one-way messages destined for a downstream application.

### Example Usage Scenario

Automated redaction system 100 may be used in a variety of contexts, and the techniques described herein are not limited to any particular context. However, for the purpose of explanation, a scenario shall be described in which user 102 is a doctor that is requesting medical information for a particular patient. In this scenario, business logic 110 may include business logic for a web-based medical information retrieval application with which the doctor may interact using a browser that is running on client 104. Initially, user 102 may cause the browser to request a page to log on to the application. As part of the log-in process, user 102 provides log-in information, such as a username/password combination. Based on the username/password, the application determines the identity of user 102.

Once user 102 has logged in to the application, the application may send to the browser of user 102 a page that contains controls with which user 102 may interact to request the desired medical information. In response to interacting with those controls, a content item request is sent from client 104 to business logic 110. In response to the request, the orchestration component 128 determines the role of user 102 relative to the requested information. Such role information may be determined, for example, based on profile information maintained by the application for user 102.

A single user may be associated with many roles. Which role applies to a user may vary based on the information that the user is requesting. For example, if a doctor is requesting information about herself, then the doctor's role may be “self”. On the other hand, if the doctor is requesting information about a patient, the doctor's role may be “primary care physician”, “specialist”, etc. For the purpose of explanation, it shall be assumed that user 102 is the “primary care physician” of the particular patient about whom user 102 is requesting information. The requested information may be, for example, the patient's medical history for the last ten years. That medical history information may be available from the CCD History service.

After having determined the role that user 102 has relative to the particular content/service that user 102 has requested, orchestration component 128 sends an authorization request 122 to authorization service 120. In one embodiment, the request includes both data that identifies the determined role (e.g. “primary care physician”), and data that identifies the requested content/service (e.g. “CCD History”). More particularly, the authorization request 122 may include values for a variety of parameters, including: subject, role, environment, action, and resource. The “action” value may indicate the service from which a content item has been requested. In this example, subject and role describe the person making the request; action describes the type of request being made; resource describes the entity being acted upon, and environment describes any contextual data involved with this request.

Using the role and service information as look-up keys, authorization service 120 identifies the authorization policies that match the role/service combination. From those matching policies, authorization service 120 determines whether the requested access is permitted and, if permitted, which information needs to be redacted, and how the redaction is to be performed. As mentioned above, the mechanism by which the to-be-redacted information is identified may be an XPath expression. The manner in which to perform the redaction may be involve one of a variety of redaction techniques, including deleting, blanking-out, or encrypting using any one of a plurality of encryption techniques.

In response to receiving the authorization response 124 from authorization service 120, the orchestration component 128 determines from the response that user 102 is permitted to access the CCD History of her patient, but that certain portions of that history need to be redacted using a particular encryption technique. In response, the orchestration component 128 makes the calls necessary to obtain the data for, and construct, a pre-redaction version of the CCH History. In the embodiment illustrated in FIG. 1, those calls may involve calling a content aggregator 112 that obtains various pieces of data from content sources 150-156 and aggregates the data into a pre-redaction version 116 of the CCD History.

Orchestration component 128 also sends a redaction request to redaction component 114 to cause redaction component 114 to generate a port-redaction version 118 of the CCD History, by encrypting, in the specified manner, those portions of the CCD History that match the XPath expression that was returned by the authorization service 120. The post-redaction version of the CCD History may then be provided to client 104.

In an embodiment that employs XACML-based response messages, the business logic 110 may be configured to insert a decryption indicator or policy description in the WS-Security header returned in the response message—consistent with the redaction method configured in the authorization policy (as per what was specified in the authorization response Obligations section). Including such a decryption indicator or policy description in the response message would facilitate understanding what element(s) need to be decrypted (if encryption was the chosen redaction method).

### In-Flow Redaction Example

In the examples given above, redaction is performed in the context of providing a requested content item to a requestor. However, the techniques described herein may be employed in other contexts. For example, in the absence of any particular request, a content item may be flowing between components within a system, or between systems. In such a context, any component that is responsible for passing the content item to another entity may, prior to providing the content item to the entity, send an authorization request 122 to authorization service 120 to determine whether the content item is permitted to be provided to the entity.

In response to the authorization request 122, the component receives an authorization response 124 that indicates whether the content item may be provided to the entity and, if so, whether any portions of the content item need to be redacted prior to providing the content item to the entity. In the case where the entity is permitted to receive the content item, but one or more portions must first be redacted, the authorization response 124 indicates which portions need to be redacted, and the manner in which the redaction should be performed. As mentioned above, the portions that need to be redacted may be identified using one or more XPath expressions.

If the component is authorized to provide the entity with the content item, but portions of the content item need to be redacted, the component provides the content item, along with the redaction instructions, to the redaction component 114. The redaction component 114 performs the requested redaction operations using the XPath expressions to identify the portions to redact, and using the specified redaction techniques. The component then passes the post-redaction version of the content item to the entity. This process may be repeated on a particular content item any number times as the particular content item flows from entity to entity within a system.

In one embodiment, a history of the redactions that have been performed on a content item is passed along with the content item. That history information may be used to avoid attempting to perform at one point in the flow redactions that have already been performed at previous points in the flow. The history information may include, for example, the XPath expressions that have served as the basis for previously-performed redaction operations.

### Advantages

Depending on how the techniques described herein are implemented, a variety of advantages may be achieved relative to convention automated redaction systems. For example, the techniques described herein may be readily applied to one of the most important in information technology environments: SOA-based transaction systems. Significantly, the techniques support the redaction (removal or encryption) of sensitive data from data flowing out of OLTP and SOA-based transactional applications; and do so using a configurable approach where the data being redacted is tied to the authorization policies configured by system administrators. These policies can be very specific or very general, and can be tied to any combination of factors.

In addition, the techniques described herein do not put any significant burden on application developers, and are generally transparent to the entire application and SOA development process. Further, the techniques described herein tie redaction to the actual authorization policies, and leverage authorization as a service. Further, the techniques due so, in one embodiment, by leveraging existing standards, such as Web Services, XPath and XACML.

The techniques described herein may be employed to produce an application-layer message that can be passed among multiple tiers and nodes across an internet or intranet; as a result, these techniques generally provide more security than conventional redaction systems.

The redaction component can be used to redact data bi-directionally: for both outgoing data as well as incoming/response data (for both one-way asynchronous messages as well as transactional request/reply messages, or any combination thereof). This redaction capability, implemented in the manner described herein, is valuable to a large percentage of customers across most every industry.

### Hardware Overview

According to one embodiment, the techniques described herein are implemented by one or more special-purpose computing devices. The special-purpose computing devices may be hard-wired to perform the techniques, or may include digital electronic devices such as one or more application-specific integrated circuits (ASICs) or field programmable gate arrays (FPGAs) that are persistently programmed to perform the techniques, or may include one or more general purpose hardware processors programmed to perform the techniques pursuant to program instructions in firmware, memory, other storage, or a combination. Such special-purpose computing devices may also combine custom hard-wired logic, ASICs, or FPGAs with custom programming to accomplish the techniques. The special-purpose computing devices may be desktop computer systems, portable computer systems, handheld devices, networking devices or any other device that incorporates hard-wired and/or program logic to implement the techniques.

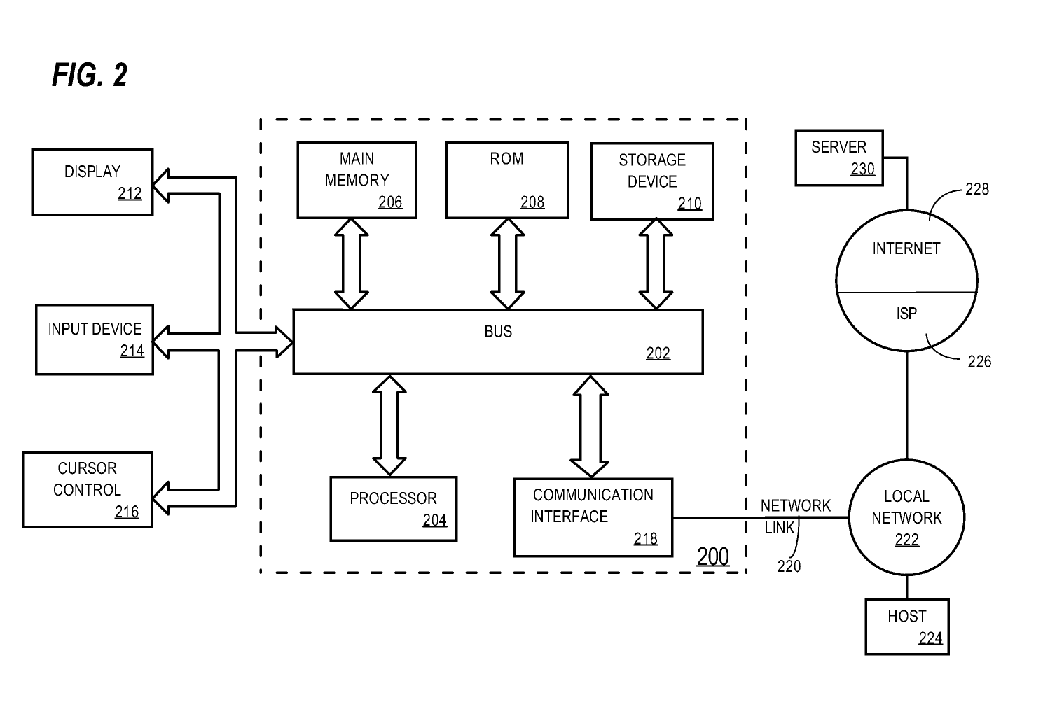

For example, FIG. 2 is a block diagram that illustrates a computer system 200 upon which an embodiment of the invention may be implemented. Computer system 200 includes a bus 202 or other communication mechanism for communicating information, and a hardware processor 204 coupled with bus 202 for processing information. Hardware processor 204 may be, for example, a general purpose microprocessor.

Computer system 200 also includes a main memory 206, such as a random access memory (RAM) or other dynamic storage device, coupled to bus 202 for storing information and instructions to be executed by processor 204. Main memory 206 also may be used for storing temporary variables or other intermediate information during execution of instructions to be executed by processor 204. Such instructions, when stored in non-transitory storage media accessible to processor 204, render computer system 200 into a special-purpose machine that is customized to perform the operations specified in the instructions.

Computer system 200 further includes a read only memory (ROM) 208 or other static storage device coupled to bus 202 for storing static information and instructions for processor 204. A storage device 210, such as a magnetic disk or optical disk, is provided and coupled to bus 202 for storing information and instructions.

Computer system 200 may be coupled via bus 202 to a display 212, such as a cathode ray tube (CRT), for displaying information to a computer user. An input device 214, including alphanumeric and other keys, is coupled to bus 202 for communicating information and command selections to processor 204. Another type of user input device is cursor control 216, such as a mouse, a trackball, or cursor direction keys for communicating direction information and command selections to processor 204 and for controlling cursor movement on display 212. This input device typically has two degrees of freedom in two axes, a first axis (e.g., x) and a second axis (e.g., y), that allows the device to specify positions in a plane.

Computer system 200 may implement the techniques described herein using customized hard-wired logic, one or more ASICs or FPGAs, firmware and/or program logic which in combination with the computer system causes or programs computer system 200 to be a special-purpose machine. According to one embodiment, the techniques herein are performed by computer system 200 in response to processor 204 executing one or more sequences of one or more instructions contained in main memory 206. Such instructions may be read into main memory 206 from another storage medium, such as storage device 210. Execution of the sequences of instructions contained in main memory 206 causes processor 204 to perform the process steps described herein. In alternative embodiments, hard-wired circuitry may be used in place of or in combination with software instructions.

The term “storage media” as used herein refers to any non-transitory media that store data and/or instructions that cause a machine to operation in a specific fashion. Such storage media may comprise non-volatile media and/or volatile media. Non-volatile media includes, for example, optical or magnetic disks, such as storage device 210. Volatile media includes dynamic memory, such as main memory 206. Common forms of storage media include, for example, a floppy disk, a flexible disk, hard disk, solid state drive, magnetic tape, or any other magnetic data storage medium, a CD-ROM, any other optical data storage medium, any physical medium with patterns of holes, a RAM, a PROM, and EPROM, a FLASH-EPROM, NVRAM, any other memory chip or cartridge.

Storage media is distinct from but may be used in conjunction with transmission media. Transmission media participates in transferring information between storage media. For example, transmission media includes coaxial cables, copper wire and fiber optics, including the wires that comprise bus 202. Transmission media can also take the form of acoustic or light waves, such as those generated during radio-wave and infra-red data communications.

Various forms of media may be involved in carrying one or more sequences of one or more instructions to processor 204 for execution. For example, the instructions may initially be carried on a magnetic disk or solid state drive of a remote computer. The remote computer can load the instructions into its dynamic memory and send the instructions over a telephone line using a modem. A modem local to computer system 200 can receive the data on the telephone line and use an infra-red transmitter to convert the data to an infra-red signal. An infra-red detector can receive the data carried in the infra-red signal and appropriate circuitry can place the data on bus 202. Bus 202 carries the data to main memory 206, from which processor 204 retrieves and executes the instructions. The instructions received by main memory 206 may optionally be stored on storage device 210 either before or after execution by processor 204.

Computer system 200 also includes a communication interface 218 coupled to bus 202. Communication interface 218 provides a two-way data communication coupling to a network link 220 that is connected to a local network 222. For example, communication interface 218 may be an integrated services digital network (ISDN) card, cable modem, satellite modem, or a modem to provide a data communication connection to a corresponding type of telephone line. As another example, communication interface 218 may be a local area network (LAN) card to provide a data communication connection to a compatible LAN. Wireless links may also be implemented. In any such implementation, communication interface 218 sends and receives electrical, electromagnetic or optical signals that carry digital data streams representing various types of information.

Network link 220 typically provides data communication through one or more networks to other data devices. For example, network link 220 may provide a connection through local network 222 to a host computer 224 or to data equipment operated by an Internet Service Provider (ISP) 226. ISP 226 in turn provides data communication services through the world wide packet data communication network now commonly referred to as the “Internet” 228. Local network 222 and Internet 228 both use electrical, electromagnetic or optical signals that carry digital data streams. The signals through the various networks and the signals on network link 220 and through communication interface 218, which carry the digital data to and from computer system 200, are example forms of transmission media.

Computer system 200 can send messages and receive data, including program code, through the network(s), network link 220 and communication interface 218. In the Internet example, a server 230 might transmit a requested code for an application program through Internet 228, ISP 226, local network 222 and communication interface 218.

The received code may be executed by processor 204 as it is received, and/or stored in storage device 210, or other non-volatile storage for later execution.

In the foregoing specification, embodiments of the invention have been described with reference to numerous specific details that may vary from implementation to implementation. The specification and drawings are, accordingly, to be regarded in an illustrative rather than a restrictive sense. The sole and exclusive indicator of the scope of the invention, and what is intended by the applicants to be the scope of the invention, is the literal and equivalent scope of the set of claims that issue from this application, in the specific form in which such claims issue, including any subsequent correction.

What is claimed is:

1. A method comprising:
prior to providing a content item to an entity, a component sending an authorization request to an authorization component;
receiving, at the component, an authorization response to the authorization request, wherein the authorization response indicates:
that the entity is permitted to access the content item; and
that one or more portions are to be redacted from the content item prior to providing the content item to the entity;
in response to the authorization response, the component sending a redaction request to a redaction component to redact the one or more portions from the content item to produce a redacted version of the content item; and
providing the redacted version of the content item to the entity;
wherein the method is performed by one or more computing devices.

2. The method of claim 1 wherein:
the component is an orchestration component;
the step of sending an authorization request is performed in response to receiving a request for the content item from the entity; and
the redacted version of the content item is provided to the entity in response to the request for the content item that was received from the entity.

3. The method of claim 1 wherein the component provides the redacted version of the content item to the entity without the entity having requested to receive the content item.

4. The method of claim 1 wherein:
the authorization response includes an XPath expression that indicates the one or more portions;
based on the XPath expression in the authorization response, the component includes the XPath expression in the redaction request; and
the redaction component redacts the one or more portions from the content item based on the XPath expression.

5. The method of claim 1 wherein:
the authorization response includes an indication of which redaction technique, of a plurality of redaction techniques supported by the redaction component, is to be used to redact the one or more portions; and
based on the indication in the authorization response, the component indicates, in the redaction request, the redaction technique that is to be used to redact the one or more portions.

6. The method of claim 1 further comprising the authorization component inspecting a set of stored policies to determine whether the entity is permitted to access the content item.

7. The method of claim 6 wherein the stored policies include a particular policy that indicates that the one or more portions are to be redacted from the content item prior to providing the content item to the entity.

8. The method of claim 7 wherein:
the particular policy indicates that a particular redaction technique is to be used to redact the one or more portions; and
the authorization response includes an indication of the particular redaction technique.

9. The method of claim 8 wherein the particular redaction technique is a particular encryption technique, of a plurality of encryption techniques supported by the redaction component.

10. One or more non-transitory computer-readable media storing instructions which, when executed by one or more processors, cause the one or more processors to execute an authorization service that is configured to perform the steps of:
receive an authorization request that indicates a role of a requestor and a requested service; and
in response to the request, send an authorization response that includes:
at least one XPath expression that identifies which portion of a content item, from the requested service, is to be redacted before the content item is provided to a requestor that has the role; and
an indication of which type of encryption, of a plurality of available types of encryption, is to be used to used to redact said portion of the content item.

11. One or more non-transitory computer-readable media storing instructions which, when executed by one or more processors, cause the one or more processors to execute a redaction component that is configured to perform the steps of:
receiving a redaction request that includes an XPath expression and an indication of a selected type of encryption, wherein the selected type of encryption is one of a plurality of types of encryption supported by the redaction component; and
in response to the redaction request, generating a post-redaction version of a content item by performing the selected type of encryption on one or more portions of a pre-redaction version of the content item, wherein the one or more portions are portions that match the XPath expression.

12. One or more non-transitory computer-readable media storing instructions which, when executed by one or more processors, cause the one or more processors to perform a method that includes:
prior to providing a content item to an entity, a component sending an authorization request to an authorization component;
receiving, at the component, an authorization response to the authorization request, wherein the authorization response indicates:
that the entity is permitted to access the content item; and
that one or more portions are to be redacted from the content item prior to providing the content item to the entity;
in response to the authorization response, the component sending a redaction request to a redaction component to redact the one or more portions from the content item to produce a redacted version of the content item; and
providing the redacted version of the content item to the entity;
wherein the method is performed by one or more computing devices.

13. The one or more non-transitory computer-readable media of claim 12 wherein:
the component is an orchestration component;
the step of sending an authorization request is performed in response to receiving a request for the content item from the entity; and
the redacted version of the content item is provided to the entity in response to the request for the content item that was received from the entity.

14. The one or more non-transitory computer-readable media of claim 12 wherein the component provides the redacted version of the content item to the entity without the entity having requested to receive the content item.

15. The one or more non-transitory computer-readable media of claim 12 wherein:
the authorization response includes an XPath expression that indicates the one or more portions;
based on the XPath expression in the authorization response, the component includes the XPath expression in the redaction request; and
the redaction component redacts the one or more portions from the content item based on the XPath expression.

16. The one or more non-transitory computer-readable media of claim 12 wherein:
the authorization response includes an indication of which redaction technique, of a plurality of redaction techniques supported by the redaction component, is to be used to redact the one or more portions; and
based on the indication in the authorization response, the component indicates, in the redaction request, the redaction technique that is to be used to redact the one or more portions.

17. The one or more non-transitory computer-readable media of claim 12 wherein the method further comprises the authorization component inspecting a set of stored policies to determine whether the entity is permitted to access the content item.

18. The one or more non-transitory computer-readable media of claim 17 wherein the stored policies include a particular policy that indicates that the one or more portions are to be redacted from the content item prior to providing the content item to the entity.

19. The one or more non-transitory computer-readable media of claim 18 wherein:
the particular policy indicates that a particular redaction technique is to be used to redact the one or more portions; and
the authorization response includes an indication of the particular redaction technique.

20. The one or more non-transitory computer-readable media of claim 19 wherein the particular redaction technique is a particular encryption technique, of a plurality of encryption techniques supported by the redaction component.
